(19) United States
(12) Patent Application Publication
(10) Pub. No.: US 2016/0108898 A1
(43) Pub. Date: Apr. 21, 2016

(54) Machine for generating green energy by the movement of solid masses along the radius of a spinning mechanical wheel

(71) Applicant: Andreas Haikalis, Astoria, NY (US)

(72) Inventor: Andreas Haikalis, Astoria, NY (US)

(21) Appl. No.: 14/520,295

(22) Filed: Oct. 21, 2014

(51) Int. Cl. F03G 3/02; H02K 7/18

(52) U.S. Cl. CPC F03G 3/02; H02K 7/1807; Y10S 74/09; F03G 7/10

(57) ABSTRACT

A machine for generating energy by moving solid masses outward along the radius of a spining mechanical wheel. The mechanical wheel is made by six to eight metal pipes extending outwardly 20 feet from a centralized hallowed circular structure. The pipes extend in all directions and are fitted with metal tracks that run dorsally. The pipes are fitted with one inch chains along their sides running their entire length. Wheels are installed at the tip allowing the side chains to emulate bicycle chain motion. Hinged 80 pound solid weights are installed on the tracks that run dorsally. The mechanical wheel is mounted on a 7 inch pipe that acts as an axle allowing the wheel to spin freely. The centralized circular structure houses a wired transmission and motor near the axle of the machine. The generator structure situated at the front of the machine is wired to the transmission producing power when wheel rotates.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of green energy production and more specifically to a machine for generating green energy by the movement of solid masses along the radius of a spining mechanical wheel.

Energy production was considered green because it had little or no harmful impacts to the environment. This invention follows along this concept. Historically green energy production has used the sun, the wind, and water as the chief ingredient in their production of green energy. This invention does not rely on these natural inputs. Rather it employs large weighted masses affixed to a track system that generate force, forces.

Prior green energy technologies have created and perfected inventions like wind mills, solar panels, dams, and water mills. This invention embraces the category of the wind mill and water mill, except for one major departure. This invention is self sufficient. It does not rely on external environmental inputs from nature such as wind, light, and water. Rather it relies on the internal movement of weighted masses to generate momentum and force to turn a mechanical wheel thus simulating the motion of the mills to generate, power. This makes the invention portable and a more reliable energy production source.

Prior technologies are too dependant on what mother nature will do. If there is not enough sun, then solar panel outputs of energy will be compromised. With out the wind then windmills do not rotate enough to produce a reliable source of energy. If water currents cease or are diverted by natural events, watermills can not work effectively. This invention only requires gravitational and centripetal forces to move hinged weights outward from the center of a wheel to the end of a 20 foot pipe creating a constant rotation of the wheel, that produces energy when harnessed. This makes the invention both practical, portable, and a non contributor of pollution.

### BRIEF SUMMARY OF THE INVENTION

The primary object of the invention is it provides a definite calibrated continuous powerful energy source.

Another object of the invention is its construction is simple and can easily be assembled and, disassembled.

Another object of the invention is it produces energy with out negative consequences to the environment.

A further object of the invention is it can be made form recycled material and eco friendly products.

Yet another object of the invention is it can be deployed on the residential and commercial level.

Still yet another object of the invention is its a low maintenance machine, only lubrication of moving parts is required.

Another object of the invention is it does not rely on traditional green energy inputs like sun, water, and wind.

Another object of the invention is it is portable and can be assembled anywhere.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for generating green energy by the movement of solid masses along the radius of a spining mechanical wheel comprising: of a metallic mechanical wheel made by six to eight metal pipes extending outwardly 20 feet from a centralized hallowed circular structure. Metal pipes extend outwardly in all directions and are fitted with metal tracks that run dorsally along the pipes. Metal pipes are also fitted with a one inch chain, along their sides running the length. Metal pipes are fitted with wheels on their most proximate ends that allows chain to rotate like a bicycle chain. Hinged 80 pound solid weights or masses are installed on the tracks that run dorsally along the metal pipes. The mechanical wheel is mounted on a 7 inch pipe structure which acts as an axle allowing the wheel to spin freely. The centralized circular structure is fitted with a wired transmission and motor near the axle. A generator structure is mounted to the front of the machine and it is wired to the transmission producing power when wheel rotates.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of the invention.

FIG. 2 is a perspective view of the invention.

FIG. 3 is a plan view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

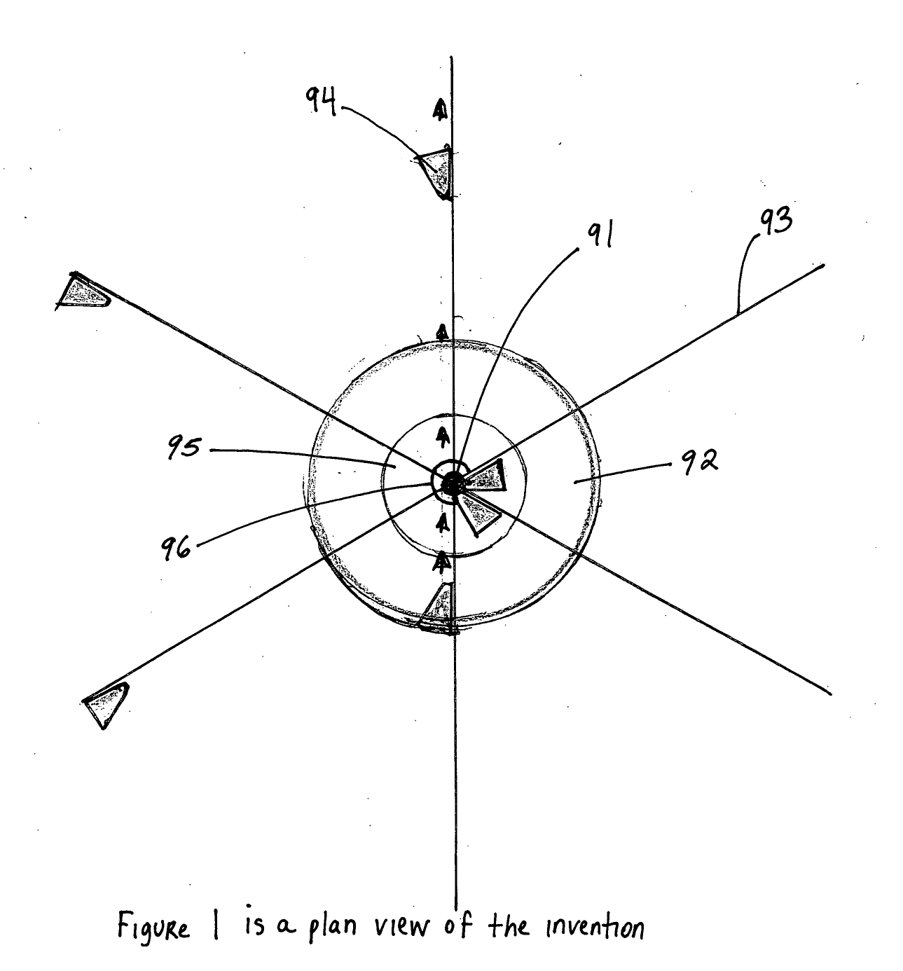

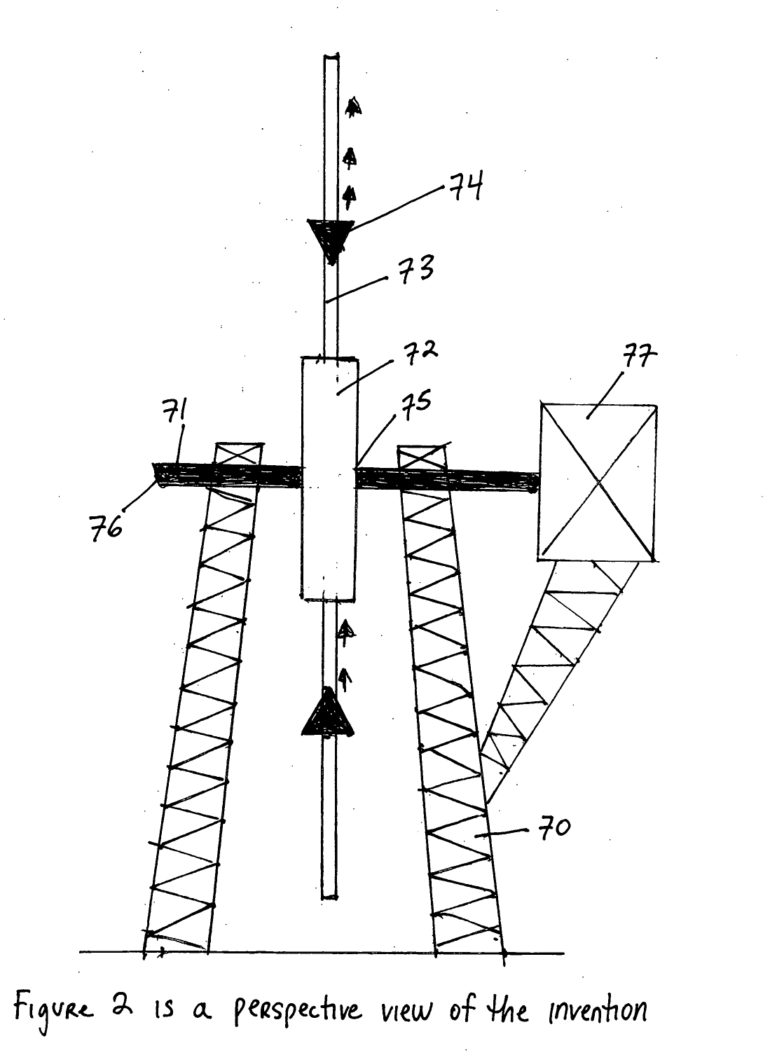

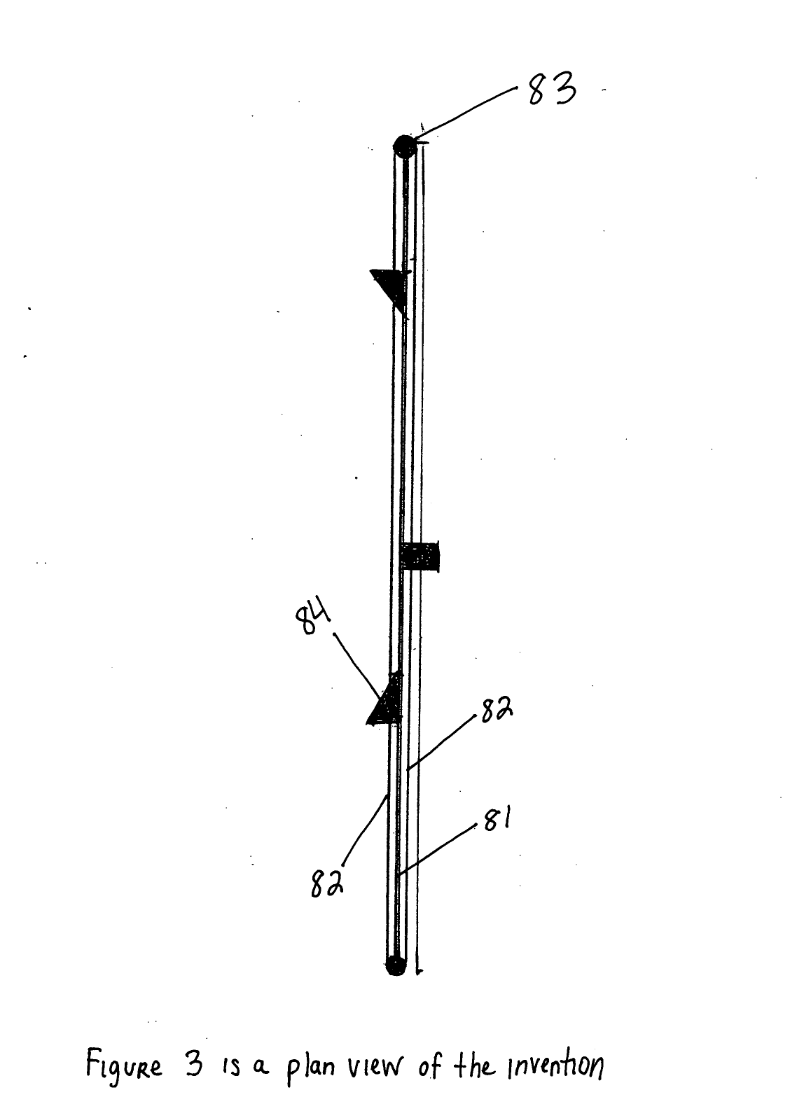

Supported by three 25 foot tall metal mesh scaffoldings (FIG. 2 #70) is a 7 inch pipe (FIG. 2 #71 and FIG. 1 #91) that runs parallel to the ground. Affixed to the center of the pipe is a giant metal wheel. The pipe acts as an axle for this wheel allowing it to move freely in a clockwise or counterclockwise motion. This mechanical wheel consists of a hallow closed metallic circular plate (FIG. 1 #92 and FIG. 2 #72) with 6 to 8 twenty foot metal bars (FIG. 1 #93 and FIG. 2 #73) extending outward in all directions. These pipes that extend outward 20 feet are fitted with a metal track system that runs dorsally on them for their entire length (FIG. 3 #81). Metal chains running the entire length (FIG. 3 #82) are also fitted to these 20 foot extending pipes (FIG. 1 #93 and FIG. 2 #73). Still further rubber or metal wheels (FIG. 3 #83) are affixed to the furthermost most tip of these 20 foot pipes allowing the affixed chains to rotate emulating bicycle chain rotation. Affixed to the tracks that run dorsally on the pipes (FIG. 3 #81) are hinged metal weights or masses bearing weight of at least 80, pounds (FIG. 1 #94, FIG. 2 #74, FIG. 3 #84). These weights move freely up and down and along the tracks. A rechargeable fuel cell 3HP motor (FIG. 1 #95. FIG. 2 #75) with wired transmission is affixed near the pipe axle (FIG. 2 #71). A switch located at the back of the machine (FIG. 2 #76) turns on the machine. At the front end of the machine there is a generator unit installed (FIG. 2 #77) wired to the transmission. Affixed to the innermost central area of the closed metallic circular plate (FIG. 1 #92 FIG. 2 #72) are metal square plates that protect the axle and also cause a rebound effect when the hinged metal weights make contact with them (FIG. 1 #96). When the wheel is not moving, all the weights above the axle are located in the center of the wheel or at the bottom of each track (FIG. 2 #81), and all the weights located below the axle are at the end or tip of the metal pipes. When the machine is switched on, the motor installed near the axle (FIG. 1 #95 and FIG. 2 #75) starts moving the chains affixed to the sides of the pipes (FIG. 3 #82). The pipes move from their at rest positions. As the wheel tilts the hinged weights move along their respective tracks. The weights above the axle (10, 12, 2 o'clock positions) move away from the center, and the weights below the axle (4, 6, 8 o'clock positions) move in towards the center of the wheel. When the weights move past the midway point along their respective tracts, the motor initially rotating the mechanical wheel is no longer deployed. The wheel moves on its own from now on. The motor is there only to supply a threshold stimulus. As a result very small quantities of energy are expended by the motor. The motor gets recharged by the generated power of the machine. Once that threshold is reached the wheel will move and rotate rapidly on its own. As the weights move up the tract towards the end of the pipe, gravitational forces and centripetal forces are very great pulling the weights downward towards the center of the earth. This downward pull spins the wheel both clockwise and counterclockwise. The mechanical wheel is rotated with a continuous rapid speed. The end results are that large quantities of electrical power are produced by the generator (FIG. 2 #77) that is wired to the transmission that is installed around the axle (FIG. 2 #71). This invention mimics that of a wind turbine but with out the need for wind, and with much greater force and energy production.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention, as defined by the appended claims.

What is claimed is:

1. A machine for generating green energy by the movement of solid masses along the radius of a spining mechanical wheel comprising:
A metallic mechanical wheel made by six to eight metal pipes extending outwardly 20 feet from a centralized hallowed circular structure;
metal pipes extend outwardly in all directions and are fitted with metal tracks that run dorsally along the pipes;
metal pipes are also fitted with a one inch chain along their sides running the length of the 20 foot pipes;
metal pipes are fitted with metal or rubber wheels on their most proximate ends that allows chain to move like a bicycle chain;
hinged 80 pound solid weights or masses are installed on the tracks that run dorsally along the metal pipes;
the mechanical wheel is mounted on a 7 inch pipe structure which acts as an axle allowing wheel to spin freely;
the centralized hallowed circular structure is fitted with a wired transmission and motor near the axle; and
the generator structure situated at the front of the machine connects to the transmission producing power when wheel rotates.
